(19) United States
(12) Patent Application Publication
(10) Pub. No.: US 2006/0048618 A1
(43) Pub. Date: Mar. 9, 2006

(54) Multi knife cutting device

(76) Inventor: Gopinath Baddepudi, Hyderabad (IN)

Correspondence Address: BADDEPUDI GOPINATH, 301, SARALARAMAM APTS, SALIMNAGAR, 16-11-310-8, HYDERABAD, 500036, IN

(21) Appl. No.: 11/041,085

(22) Filed: Jan. 24, 2005

Related U.S. Application Data
(63) Continuation-in-part of application No. 10/042,433, filed on Jan. 10, 2002, now abandoned.

(51) Int. Cl. B26D 1/30

(52) U.S. Cl. 83/607; 83/932

(57) ABSTRACT

A manual multi knife cutting device for vegetables and other material of similar structure 5 wherein: the knives are mounted directly in a base cum guide containing slots and filcrum bolt for the knives, and an enclosure cum platform for the vegetables right next to the knife fulcrum.

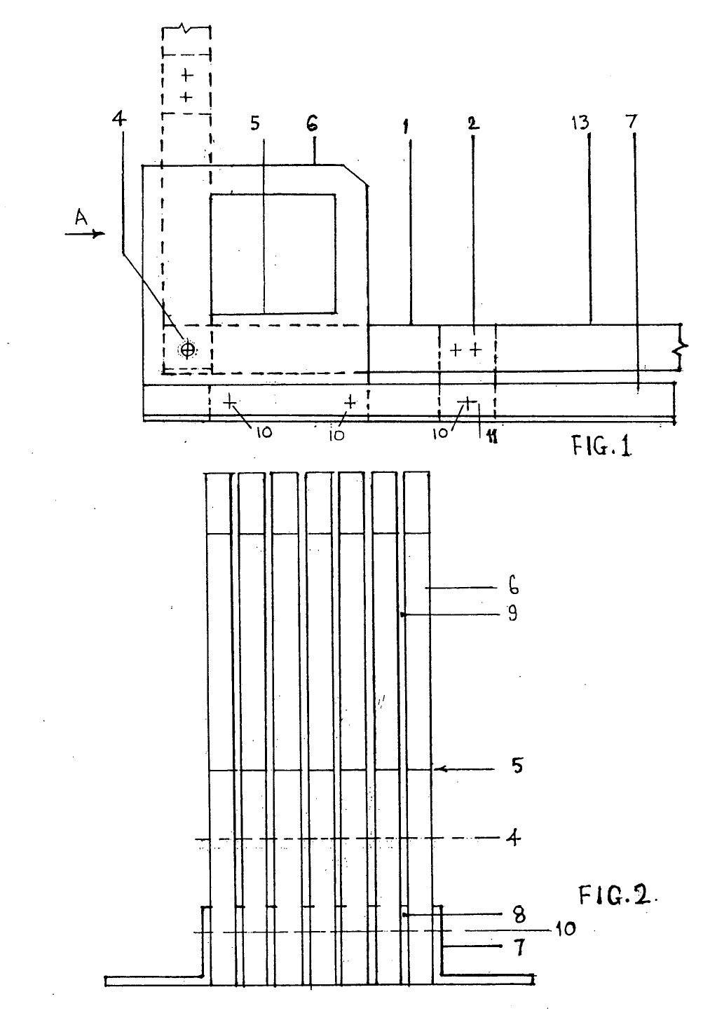

The enclosure location close to the fuilcrum reduces cutting loads and it's closed design prevents vegetable sliding. The guides which make up the base using spacers and connecting bolts at the bottom fudly support the knives throughout the cutting stroke enabling a smooth cut. Slots 0o extending below the platform enable the knives to go past the cut pieces for a clean cut. The best mode is illustrated in FIG. 1.

### CROSS REFERENCE TO RELATED APPLICATIONS

This application is a Continuation In Part application, claiming the benefit of my prior nonprovisional application Ser. No. 10/042,433 of filing date Jan. 10, 2002, under 35 USC. 120.

However I would like to mention that my application no. 98/MAS/2001 dated 5^{th} Feb. 2001 is pending with the Patent office, Chennai, for the same invention. Several improvements and modifications, with are a result of testing the proptotypes after Feb. 1^{st} 2001, have been included in the U.S. application Ser. No. 10/042,433.

### STATEMENT REGARDING FEDERALLY SPONSORED RESEARCH

Not applicable

### REFERENCE TO A MICRO FICHE APPENDIX

Not applicable

### BACKGROUND OF THE INVENTION

The invention described in this application belongs to a field of kitchen gadgets for cutting vegetables which are labor saving. The subject matter of the invention falls under the U.S. patent classification “083—CUTTING”.

I am listing below some prior art cutting devices with U.S. patents which I came across during a search in the database.

| U.S. Pat. No. | Title |
|---|---|
| 6,148,704 | Vegetable cutting device |
| 6,052,910 | Vegetable cutting device |
| 5,950,515 | Apparatus for slicing vegetables |

There are some more patented multiple knife cutting devices, a list of which is enclosed. Problems in the prior art multi knife devices are as follows.

Buckling of knives under load, vegetables remaining stuck between the knives, sliding of vegetables, increase in the load arm due to knive frames and consequent reduction in the lever advantage. It may also be noted that though there are patents for multiple knife cutting devices, the devices are not a common sight in the market. I have not seen any in the supermarkets.

The device, which I have invented, is structurally and functionally different from these prior art devices.

The components used in my invention are rectangular plate elements, knives, handles, fasteners, plastic parts etc, which are items in common use. They have been designed and assembled in a novel way to obtain a new and effective device for cutting vegetables.

I was motivated to invent a more productive multi knife device after seeing the drudgery inherent in cutting vegetables with a single utility knife.

### BRIEF SUMMARY

The invention “Multi knife cutting device comprises a novel base cum guide and three pairs of knives directly mounted on the base cum guide. The object of the invention is to provide a trouble free multi knife vegetable cutting device which is time and labor saving. the novel design features which make it different from prior art detailed in the section “Detailed description of the Multi knife cutting device”.

The best embodiment will be described in the following pages.

The advantages of the new invention are:

The increase in productivity; the time and effort saving and use of lever action to gain mechanical advantage.

The novel design features in the invention have created a better device as described below.

The buckling or misalignment of knives is minimised due to comprehensive guiding by new type of guide elements. The cutting effort is reduced by reducing the load arm. Sliding of vegetables is prevented. The cut pieces do not remain stuck between the knives after the cut.

BRIEF DESCRIPTION OF DRAWING VIEWS.

| Sheet no. | FIG. no. | Details |
|---|---|---|
| 1/2 | 1 | Elevation view. Dotted lines |
| | | show knife starting position. |
| 1/2 | 2 | End view of base cum guide, |
| | | without knives, direction A. |
| 2/2 | 3 | Plan View of device, knife |
| | | handle arrangement, Knives |
| | | in horizontal position. |

### DETAILED DESCRIPTION OF THE MULTI KNIFE CUTTING DEVICE

This is a new getable cutting device using multiple knives with several innovative features, making it distinct from any other cutting device. These features will be described at the end of this section. The details of the drawing figures are given below.

Fig. no. 1. Elevation view, knives horizontal, dotted lines show knives in vertical position.

Fig. no. 2. End view in direction A of FIG. 1, of base cum guide without knives,

Fig. no. 3. Plan view of device and the knife handle arrangement, knives horizontal.

PART LIST

| Part no. | Name | Quantity | Material | Dimension., mm |
|---|---|---|---|---|
| 1 | Knife | 6 | SS 420 | 1 × 24 × 160 |
| 2 | screw | 12 | Steel | 4 dia |
| 3 | handle | 1 | Al/laminate | 6 × 24 × 160 |
| 4 | fulcrum | 1 | Steel | 4 dia |
| | screw | | | |
| 5 | Vegetable | 1 | Aluminum/laminate | 60 × 60 |
| | enclosure | | | |
| 6 | Guides | 7 | Aluminum/Laminate | 6 × 129 ht |
| 7 | base angle | 2 | Aluminum | 2 × 20 × 25 |
| 8 | Spacers | 6 | Laminate plastic | 2 × 20 × 76 |
| 9 | Slots for | 6 | | 2 wide |
| | knives | | | |
| 10 | screws | 12 | Steel | 4 dia |
| 11 | End stop | 1 | Wood/plastic | |
| 12 | U type | 1 | Aluminum | 3 × 24 × 165 |
| | handle | | | |
| 13 | U type | 1 | Aluminum | 3 × 24 × 175 |
| | handle | | | |

Construction Details of Multi Knife Cutting Device

The appearance of the device is shown in FIG. numbers 1, 2 and 3. The materials and dimension details are given in the part list above. The multi knife cutting device comprises of two sub assemblies, base cum guide with part numbers 6,7,8,10 and the cutting means with part numbers 1,2,3,4,12,13.

Base Cum Guide:

This is the main component of the device having a novel design and multi function capabilities. Part 6 is a guide made of 6 mm thick aluminum plate or laminated plastic sheet and it has a rectangular shape, with 60×60 mm square cutout in the middle portion as seen in FIG. 1. The guide also has a fulcrum hole to receive the fulcrum screw (4), for mounting the nives to the left of the square cutout as seen in FIG. 1. Seven numbers guide are assembled together, with two base angles (7) one each on either side at the bottom edge of the guide and included in the assembly are six spacers part 8 inserted between the seven guides at the bottom edge. The spacers create six, 2 mm wide slots (9) betwee the seven guides. Screws 10 are used for the above assembly.

After the assembly as explained above, the 60×60 cutouts in all the guides together form an enclosure called vegetable enclosure part 5. The vegetables can be placed inside the vegetable enclosure and the vertical wall at the back (away from the fulcrum hole) provides solid support to prevent sliding of the vegetables. The fulcrum holes in part 6 are all aligned after assembly and ready for mounting the cutting means through part 5 fulcrum screw.

Cutting Means, part numbers 1,2,3,4,12,13:

The cutting means includes siv knives part 1 with fulcrum hole at one end and holes for handles at the other end. The six knives are formed into three pairs. Assuming that the knives are numbered in sequence from 1 to 6, 1 and 6 is the outer pair, 2 and 5 is the middle pair, 3 and 4 is the inner pair. the inner pair is fitted with a straight handle part 3, the middle pair with U type handle 12 and the outer pair with U type handle 13. Part 2 screw is the connecting element between the knives and handles.

The knives are connected to the base cum guide by direct mounting, that is without using a knife frame. The six knives part 1 are located in the six slots (9) of the base cum guide matching the fulcrum holes of both. The knives are connected to the base cum guide with the fulcrum screw (4). Washers are used between the knife and the guides in the fulcrum area so that the knives will move without play.

Movement of Knives:

The knives move from the vertical to horizontal position in pivot action for the cutting stroke. They are stopped in the horizontal position by the end stop part 11 fitted between the two angles (7) in a location matching with the knife and handle joint in the horizontal position. The handles of the knives act as levers with respect to the fulcrum in the base cum guide.

Functional Description.

The device is placed on a flat surface as shown if FIG. 1. The three pairs of 6 knives (1) are taken to the vertical position which is the starting position for cutting. The vegetables are placed in the vegetable enclosure (5). The knives are pushed clockwise by holding the three handles mentioned above together at the end, to gain maximum lever advantage. The stroke comes to an end in the horizontal position after cutting the vegetables in the enclosure, entering the guide slots below the enclosure, touching the end stop part 11. As the knives have traveled past the vegetables after cutting them, the cut pieces are lying free on the platform and can be removed by pyushing with a wooden piece or by tiling the whole device to the right.

Now the device is ready for the next cycle of the cutting operation.

This embodiment is the best mode because of the following.

It is designed to cut a full potato of section 50×60 mm into slices and then silces into fingers. For the first operation of slicing, the outer two pairs of knives are to be used first for cutting while the inner pair of knives is pressing the potato in the middle. The inner knives can be pushed down immediately after the outer knives become horizontal. The procedure is same for cutting slices into fingers. For dicing 6 ti 8 fingers of potatores, all six knives can be used at a time.
For cutting green vegetables like 6 numbers Okra or French beans at a time all the three pairs having a total of 6 knives can be used simultaneously saving both time and effort. The cutting is smooth and the device is convenient to use.
   The design features of this invention which are novel and make it differnt from prior art references are explained below.

The Base Cum Guide Structure Comprising of Parts 6,7,8,10, FIG. 1,2.

The construction of the base cum guide has been described in an earlier section. It is a novel design to combine seven plate like elements to make a versatile strcture for this device. The device is compact, sturdy and easy to manufacture.

The various capabilities of the multi function base cum guide structure are listed below:

a) Direct mounting of the knives on the fulcrum hole through a fulcrum screw;
b) The slots housing the knives and preventing knife misalignment as knives cannot go out from the slots,
c) Guiding the full length of the knife as the guides are present on both sides from beginning to the end of knife tranvel; This minimizes knife side bending and misalignment caused by loads due to simultaneous cutting resulting in the compression of the vegetables between the knives. The knife portion which passes through the enclosure is not guided but this is kept to a minimum and the guiding extends beyond the enclosure again.
d) Provision of the vegetable enclosure within the guides, close to the knife fulcrum.
e) Functioning as a base for the device, in addition to all other functions.

Vegetable Enclosure Part 5, FIG. 1.

As seen in FIG. 1, the vegetable enclosure is formed within the base cum guide assembly, adjacent to the knife fulcrum. This feature reduces considerably the distance from the fulcrum to the cutting load thus increasing the mechanical advantage.

The enclsoure effectively stops the vegetables from sliding during cutting as they are supported by the vertical back wall of the enclosure. This feature enables cutting to start from the vertical position of the knife. In the prior art the supports are not rpesent or if present, not of sufficient size to stop sliding.

As the enclosure is closed on four sides, the vegetables become self supporting. There is no need to hold them during cutting.

The Guide Slots Below the Vegetable Enclosure.

The advantage of these slots in clearing the cut pieces from the knives is explained in the section on functional description. The end stop, limiting the tranvel fo the knives in horizontal position ensures that the knife edges are saved from damage, caused by the edges touching the bottom of the base strcture.

Mounting of Knives and Cutting Action.

In this invention, a separate frame to hold the knives in place has not been used. The knives are mounted directly on the base cum guide using only a fulcrum screw part 4, FIG. 1. This is a novel feature which reduces the distance between the fulcrum and the load, increasing the mechanical advantage.

The direct mounting makes the device simple and compact.

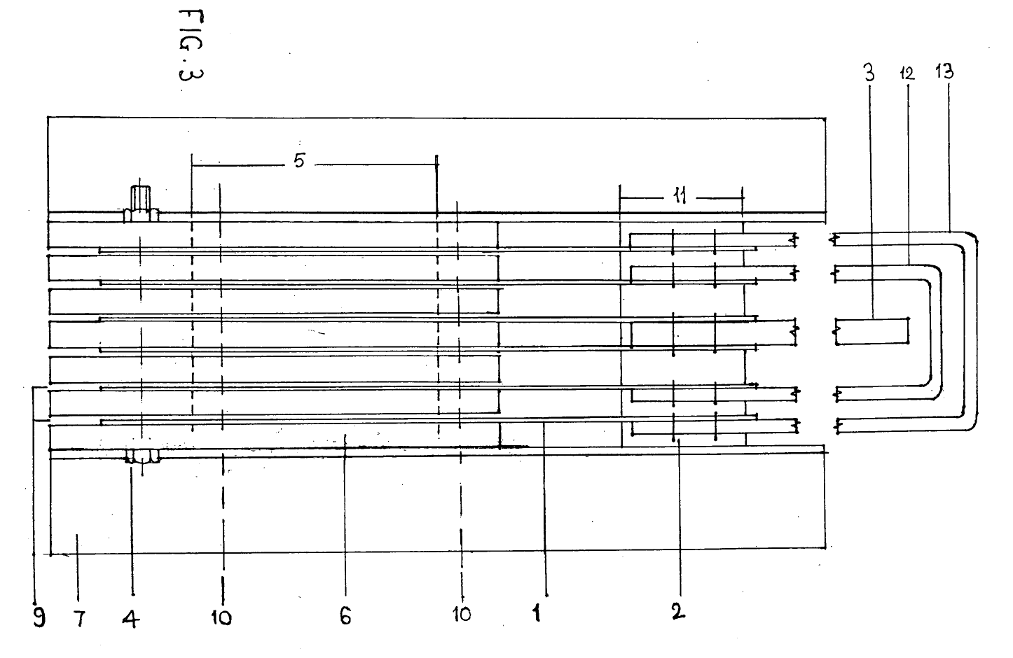

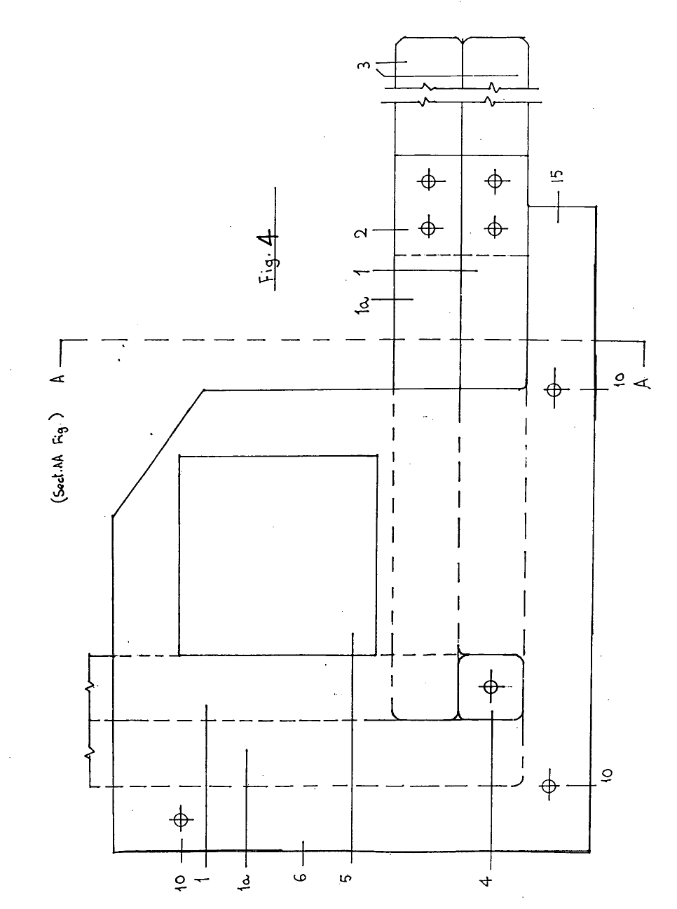

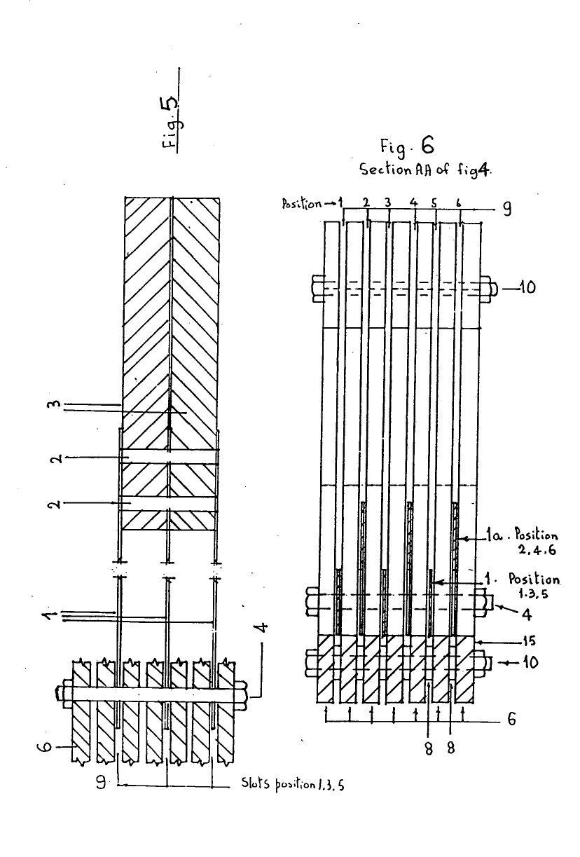

It also facilitates the possibility of using 2, 4 or 6 knives at a time, as the knife handles are joined to form three separate pairs as shown in FIG. 3.

This is very useful when cutting hard and large vegetables.

The absence of knnife frame increases access to the device and also eliminates the fouling of large vegetables with the long side members of the knife frame.

All the above features make the device compact, sturdy, easy to use and very effective in making smooth cuts with multiple knives.

Cutting Action.

In this invention the cutting action is very efficient as compared to multiple knife cutting devices of prior art. In the existing devices with pivot action of knives, the vegetables do slide till the knives form an angle closer to 45 degrees so that the knives can press the vegetables down. this happens as the small prongs or peges cannot resist the force applied to the handle for cutting.

In the new invention, the vegetables are boxed in a vegetable enclosure 5 which has a solid back wall supporting the vegetables against sliding. The knives in vertical position, are adjacent to the enclosure touching the vegetables. When the knife handles are pulled for cutting, they start cutting the vegetables even from vertical position, as the vegetables are very close to the knives in the starting position and the vegetables are prevented from sliding. This cutting action described above is not present in prior art due to larger distance between the vegetable and fulcrum caused by knife frame and the absence of fool proof anti sliding structures

Other Design Variations with the Same Principle

The description of the embodiment in the preceding pages is considered as an illustration of the design principles of the invention and is not an exhaustive collectoin of all the variations. The invention is not limited to the embodiment described in this application. All feasible modifications and variations within the scope of the invention may be resorted to in due course.

I claim:

1. A multi knife cutting device comprising:
a base cum guide containing an assembly of seven rectangular sheet guide elements with spacers in between at the bottom and support angles on either side also at the bottom, the said base cum guide assembly containing a vegetable enclosure in the middle in the form of a square cut out from the said guide elements, for boxing in the vegetables, the said base cum guide containing a fulcrum hole been the guide edge and the said vegetable enclosure, below the enclosure bottom level, a cutting means of six knives mounted directly on the said fulcrum hole using a fulcrum bolt, locating the knives in between the said guide elements, a handle arrangement in which the inner two knives are connected to one handle, the outer two knives to a U type handle and the middle two knives are connected to another U type handle, the three pairs connected as described, being free to move one pair at a tiine or two or 15 three pairs at a time, an end stop located between the said angles to limit the knife travel in horizontal position, the capability of the device ; of comprehensive knife guiding resulting from the said knife location between the said guide elements, stopping vegetable sliding by the said enclosure boxing in the said vegeiabies, ireeing otihe said vegetable cut pieces after the cut, direct mounting ofthe said knives on the said guide assembly without a inife fame, cutting eveaI from the vertical position of the said knives being made possible by direct mouting of knives adjacent to the said vegetable enclosure, which feature also increasing the mechanical advaitage.

2. A multi kife cutting device comprising;
a base cum guide containing seven guiud elements (6) murde fromTectangular sheet elements, spacers (8) and two supporting angles (7), the said guides containing a square cutout (5) in-the middle and a fuilcrum hole below the cutout ,between the guide edge and the cutout, the said seven guide elements being assembled with connecting means (10) at the bottom, with said spacers in between at the bottom and with the said -two angles at the base of the guides one on each side to -form the said base cum guide, the said guide elements after assembly forming six slots (9) between them, the said cutouts in the said guides after assembly, forming a square vegetable enclosure for boxing in the vegetables for cutting, a cutting means including six knives (1)with f-lcrum hole at one end ard holes for handles at the other end, one straight handle (3) and two U type handles (12,13) for the knives, a fulcrum bolt (4) with washers for mounting the said knives on the said fulcrum hole, an end stop (I ) fitted between the said support angles, the location being below the said knife handle holes in horizontal position.

3. The multi knife cutting device as defined in claim 2 further comprising:
the said six knives being positioned in the said slots between the guides to -match with fticmin hie andl connected by said filcrwn bolt -to the said base cum guide, the said straight knife handle being connected to the inner pair of the six knives, the inner is -Piani veuirig rin ivulibeis 3,4 X a sequence o f the knives 1,2,3,4,5,v, one of the said U type knife handles being connected to the outer pair of the kniaves 1,6 and the second U type handle being connected to the middle pair of the knives 2,5, the arrangement of the said six knives into the aforesaid three pairs , facilitating flexibility in choosing the number of pairs to be used in cutting, depending on the resisiance of a particular 15 vegetable to simultaneous cutting,

4. The multi knife cutting device as defined in claim 2, further comprising:
the said guides functioning as full size guides for the said knives which are located betweei lie guides resulting in minimizing kimie deflection wider load and ensuring that the said knives stay in aligimient, the said guide slots formed by the said guides which extend below the said vegetable enclosure, facilitating the said knives to travel below the said vegetable enclosure, resltiug in cut pieces becoming free from the knives, the said vegetable enclosure boxing in the said vegetables with solid back wail support for the said vegetables, preventing vegetable sliding resulting from cutting loaus, the said vegetable enclosw e being adjacent to the said fulcrum hole reducing the distance between the fulcrum and the load thus increasing the-mechanical advantage and also making it possible for the cut to start from the vertical position of the said knife without the sliding as the said vegetables are boxed in and in contact with the vertical knife.

5. The multi knife cutting device as defined in claim 2 wherein, the said base cum guide in addition to being base and fidi size knife guide, also contains the said vegetable enclosure and the said fulcrum hole which facilitates direct mounting of the said knives adjacent to the said vegetable enclosure resulting in reduced load armi of the lever, which capabilities make it a nmulti functional entity.

6. A multi knife cutting device. comprising:
a base cum guide consisting of a plurality of sheet type guide elements, assembled together with spacers and screws, a cutting means consisting of two groups of a plurality of knives, a fulcrum means of connection between the said cutting means and the base cum guide, consisting of a fulcrum bolt being located in the base cum guide.

7. The multi knife cutting device of claim 6 futwher comprising:
the said base cum guide having a square cutout in the middle as a vegetable enclosure, the said base cum guide consisting of seven of the said sheet type guide elements forming six slots between them, the said slots being meant for locating the knives of the said cutting iiieafis, the said two groups of knives of the said cutting means consisting of three knives each, with a fulcrum hole at one end and a provision for a common handle assembly at the other end, one group of the said two groups of knives having offset fulcrum holes enabling a position difference between the longitudinal axes of the two groups, separating the plane of the cutting edges of the knives of the two said groups, the Irives of each of the said two groups being located in the said guide slots in alternate positions, the three knives of each of the said groups being assembled together with common handles at the said handle ends, both of the said knife groups being connected to the said base cum guide by the fidcrum bolt of the said fulcrum means, the said knife assemblies having a pivot action on the fulcrum at different levels enabled by the offset filicrum holes of one of the said group of knives, both of the said groups of knives travelling below the vegetable enclosure after cutting, coming to rest in the guide slots below the enclosure.
